(19) United States
(12) Patent Application Publication
(10) Pub. No.: US 2024/0330708 A1
(43) Pub. Date: Oct. 3, 2024

(54) MODEL TRAINING METHOD AND FACE RECOGNITION METHOD BASED ON ADAPTIVE SPLIT LEARNING-FEDERATED LEARNING

(71) Applicant: Xidian University, Xi’an (CN)

(72) Inventors: Nan Cheng, Xi’an (CN); Jinglong Shen, Xi’an (CN); Zhisheng Yin, Xi’an (CN); Ruijin Sun, Xi’an (CN); Changle Li, Xi’an (CN)

(21) Appl. No.: 18/737,953

(22) Filed: Jun. 8, 2024

Related U.S. Application Data
(63) Continuation of application No. PCT/CN2023/081800, filed on Mar. 16, 2023.

(30) Foreign Application Priority Data
Apr. 2, 2022 (CN) 2022103453239

(51) Int. Cl. G06N 3/098; G06N 3/04

(52) U.S. Cl. CPC G06N 3/098; G06N 3/04

(57) ABSTRACT

A model training method based on adaptive split learning-federated learning includes: each user terminal uploading device information to the server and the server allocating a propagation step length and a aggregation weight to each user terminal; each user terminal obtaining a current-round global model from the server and taking itself as a start node of a ring topology to perform local joint processing for a preset number of times to obtain a locally-updated model parameter of the start node with respect to current-round training; each user terminal uploading the locally-updated model parameter for the current-round training to the server for aggregation and obtaining a current-round updated global model; and the server determining whether the current-round updated global model meets a convergence condition, if not, performing next-round training, or if yes, determining the current-round updated global model as a trained face recognition model.

### CROSS-REFERENCE TO RELATED APPLICATIONS

The application a continuation of International Patent Application No. PCT/CN 2023/081800, filed on Mar. 16, 2023, which claims the priority of Chinese Patent Application No. 202210345323.9, filed on Apr. 2, 2022, both of which are herein incorporated by reference in their entirety.

### TECHNICAL FIELD

The disclosure relates to the field of machine learning (ML), particularly to a model training method and a face recognition method based on adaptive split learning-federated learning.

### BACKGROUND

In recent years, ML has achieved remarkable performance in numerous tasks, such as computer vision, natural language processing, and speech recognition, owing to its excellent representation and learning capabilities. For instance, the face recognition technology based on ML is widely applied in fields like smart homes and security surveillance.

ML typically requires a substantial amount of data and computation resources to train models with good generalization performance. As a result, the approach of centralized learning has been widely adopted. In the centralized learning, a central server possesses vast amounts of data and trains models using abundant computation resources. However, in the face recognition task, the training data is generated by users, submitting this raw data (i.e., training data) to the central server located in the cloud can compromise user privacy. With the exponential growth in computation and storage capabilities of user devices, it becomes feasible to utilize local resources for learning tasks. Therefore, federated learning (FL), proposed by Google® in 2016, has garnered widespread attention and has been applied to some face recognition tasks.

In FL, ML models are trained on the user devices while maintaining the localization of model data. By submitting updated local gradients to the central server for aggregation rather than submitting the raw data, user privacy can be protected to some extent. However, the user devices participating in FL training may exhibit heterogeneity issues, that is, significant variations in the computation capability, battery life, and data distribution, which can affect the efficiency of FL. Additionally, the user data can still be at risk of privacy leakage in the face recognition tasks with traditional FL, as it can be reconstructed by eavesdropping on the transmitted model weights or gradients.

In response to the aforementioned challenges, existing solutions are incapable of addressing the heterogeneity issue of participating user devices if the data on each user device is assumed to be independent and identically distributed (IID). In the face recognition tasks, if straggled devices (i.e., laggards) due to computation resource or energy constraints are not properly scheduled, the FL model may exhibit biases, leading to suboptimal performance on those laggards (particularly those with limited network bandwidth or access restrictions that prevent continued training). Moreover, due to various reasons such as sensor placement, some user devices may consistently possess “more important” data. Thus, it is crucial to include these devices' data in the training, even if their computation capabilities are weak, current solutions fail to effectively resolve this issue. Additionally, to enhance the privacy protection in the face recognition tasks, most existing solutions have developed additional mechanisms, often at the cost of system efficiency or model performance.

Therefore, devising a model training method that addresses the heterogeneity of participating user devices and strengthens privacy protection for face recognition tasks, and subsequently utilizing the trained model to achieve accurate face recognition, is an urgent problem that needs to be addressed.

### SUMMARY

To solve the above problems in the related art, the disclosure provides a model training method and a face recognition method based on adaptive split learning-federated learning. The technical problems to be solved by the disclosure are realized by the following technical solutions.

In a first aspect, an embodiment of the disclosure provides a model training method based on adaptive split learning-federated learning, applied to a ring structured federated learning (RingSFL) system including: a server and multiple user terminals; and the model training method includes:
uploading, by each user terminal, device information thereof to the server, and allocating, by the server, a respective propagation step length and a respective aggregation weight to each user terminal based on the device information obtained from the user terminals; the propagation step length representing a number of propagation network layers;
in a current-round training, obtaining, by each user terminal, a current-round global model from the server, and taking, by each user terminal, itself as a start node of a ring topology formed by the user terminals to perform local joint processing of start nodes respectively corresponding to the user terminals for a preset number of times, thereby to obtain a locally-updated model parameter of each start node with respect to the current-round training; the local joint processing of each start node including:
   performing forward propagation and backward propagation on a current-time local model of the start node in the current-round training based on a batch of a face image training set of the start node; and
   updating the current-time local model of the start node based on weighted gradients generated by the start nodes in the local joint processing; a current-time local model corresponding to first local joint processing of each start node in the current-round training being the current-round global model; the forward propagation and the backward propagation being completed by combining partial network trainings respectively performed by the user terminals in the ring topology by using the respective propagation step lengths; and in the backward propagation, each user terminal obtaining a corresponding one of the weighted gradients by using the propagation step length thereof and the aggregation weight corresponding to the start node, and transmitting an output layer gradient thereof;
uploading, by each user terminal, the locally-updated model parameter for the current-round training to the server for aggregation, and obtaining a current-round updated global model;
determining, by the server, whether the current-round updated global model meets a convergence condition;
in response to the current-round updated global model failing to meet the convergence condition, taking the current-round updated global model as a next-round global model (i.e., the current-round global model of the next-round training), and returning to perform the step of in the current-round training, obtaining, by each user terminal, the current-round global model from the server; and
in response to the current-round updated global model meeting the convergence condition, determining the current-round updated global model as a trained face recognition model.

In an embodiment, the steps of uploading, by each user terminal, device information thereof to the server, and allocating, by the server, a respective propagation step length and a respective aggregation weight to each user terminal based on the device information obtained from the user terminals, include:
uploading, by each user terminal, a computation capability value thereof and a number of training samples corresponding to the face image training set thereof to the server;
calculating, by the server, the propagation step length of each user terminal by using a pre-established propagation step length computation formula based on the computation capability values of the user terminals; where the propagation step length computation formula is determined according to a pre-established optimization problem regarding computation time;
calculating, by the server, a total number of the training samples of the user terminals, and determining a ratio of the number of the training samples of each user terminal to the total number of the training samples as the aggregation weight of each user terminal; and
sending, by the server, the respective propagation step length and the respective aggregation weight to each user terminal.

In an embodiment, the pre-established optimization problem regarding computation time, includes:

$${min}_{{p}_{1} , … , {p}_{N}} max \{ \frac{{p}_{1} MN}{{c}_{1} C} , \frac{{p}_{2} MN}{{c}_{2} C} , … , \frac{{p}_{N} MN}{{c}_{N} C} \} \\ s . t . {\sum }_{i = 1}^{N} {p}_{i} = 1 , ∀ i = 1 , … , N \\ 0 \leq {p}_{i} \leq 1 , ∀ i = 1 , … , N$$

where pᵢ represents a cutting ratio, which indicates a computation load rate allocated to an i-th user terminal uᵢ; N represents a total number of the user terminals; Cᵢ represents a computation capability value of the user terminal uᵢ;

$$C = {\sum }_{i = 1}^{N} {C}_{i}$$

represents a total computation capability value of the user terminals; cᵢ represents a ratio of the computation capability value of the user terminal uᵢ to the total computation capability value of the user terminals; M represents a total amount of computation required for the start node to complete the local joint processing; max {□} represents obtaining a maximum value; and

$${min}_{{p}_{1} , … , {p}_{N}}$$

represents minimization.

A solution result of the pre-established optimization problem regarding computation time includes:

$$\{ \begin{matrix}{p}_{i}^{*} = {c}_{j} , ∀ i = 1 , … , N \\ {m}^{*} = \frac{M N}{C}\end{matrix}$$

where pᵢ represents an optimal cutting ratio of the user terminal uᵢ; and m′ represents a optimization result of a variable m introduced in a process of solving the pre-established optimization problem.

In an embodiment, the pre-established propagation step length computation formula is expressed as follows:

$${L}_{i} = {p}_{i}^{*} w = \frac{{C}_{i}}{{\sum }_{j = 1}^{N} {C}_{j}} w$$

where Lᵢ represents the propagation step length of the user terminal uᵢ; and w represents a total number of layers of an original network corresponding to each round global model.

In an embodiment, for each start node, the forward propagation in the local joint processing of each start node includes:
forward propagating, by the start node, at least one layer (i.e., one or more layers corresponding to the number of layers) corresponding to the propagation step length of the start node by using the batch of the face image training set thereof from a first layer of the current-time local model, and transmitting, by the start node, a feature map output by a local network corresponding to the forward propagation of the start node and an output layer serial number of the user terminal corresponding to the start node to a next user terminal along a forward direction of the ring topology starting from the start node;
for each forward current node traversed sequentially along the forward direction of the ring topology, taking a next layer corresponding to an output layer serial number of a previous user terminal along the forward direction of the ring topology as a start layer of the forward current node, forward propagating at least one layer corresponding to the propagation step length of the forward current node by using a computation result transmitted by the previous user terminal from the start layer of the forward current node, and transmitting a computation result obtained by a local network corresponding to the forward propagation of the forward current node to a next user terminal along the forward direction of the ring topology; where the forward current node is one of the user terminals traversed except the start node in the ring topology, and an end node is a last user terminal of the user terminals traversed in the ring topology; except the end node, each forward current node transmits an output layer serial number thereof to a next user terminal; the computation result obtained by the local network is a feature map output by the local network corresponding to the forward propagation of the forward current node; and a computation result of the end node is a face recognition result;
comparing, by the start node, the face recognition result transmitted by the end node with a sample label in the batch (i.e., current batch) of the face image training set to obtain a comparison result, and calculating a network loss value corresponding to the start node according to the comparison result.

In an embodiment, for each start node, the backward propagation in the local joint processing of each start node includes:
transmitting, by the start node, the network loss value and the aggregation weight corresponding to the start node to the end node;
backward propagating, by the end node, at least one layer corresponding to the propagation step length of the end node from a last layer of the current-time local model by using the network loss value, calculating, by the end node, a local network gradient of a local network corresponding to the backward propagation of the end node, multiplying, by the end node, the local network gradient with the aggregation weight of the start node to obtain a weighted gradient corresponding to the end node and storing the weighted gradient corresponding to the end node; and transmitting the output layer gradient of a local network corresponding to the end node and an output layer serial number of the end node to a next user terminal along a backward direction of the ring topology;
for each backward current node traversed sequentially along the backward direction of the ring topology, taking a next layer corresponding to an output layer serial number of a previous user terminal along the backward direction of the ring topology as a start layer of the backward current node, using an output layer gradient transmitted by the previous user terminal to backward propagate at least one layer corresponding to the propagation step length of the backward current node from the start layer of the backward current node, calculating a local network gradient corresponding to the backward propagation of the backward current node, and multiplying the local network gradient with the aggregation weight of the start node to obtain a weighted gradient of the backward current node and storing the weighted gradient of the backward current node; and transmitting an output layer gradient and an output layer serial number of a local network corresponding to the backward current node to a next user terminal along the backward direction of the ring topology; where the backward current node is one of the user terminals traversed except the start node and the end node in the ring topology; and
taking, by the start node, a next layer corresponding to an output layer serial number of a previous user terminal in the backward direction of the ring topology as a start layer of the start node, backward propagating, by the start node, at least one layer corresponding to the propagation step length of the start node from the start layer of the start node by using an output layer gradient transmitted by the previous user terminal, calculating, by the start node, a local network gradient corresponding to the backward propagation thereof, and multiplying, by the start node, the local network gradient with the aggregation weight of the start node to obtain the weighted gradient corresponding to the start node and storing the weighted gradient.

In an embodiment, the step of updating the current-time local model of the start node based on weighted gradients generated by the start nodes in the local joint processing, includes:
calculating a sum of the weighted gradients corresponding to the start node based on the weighted gradients generated in the local joint processing performed by the start nodes; and
calculating a product of the sum of the weighted gradients corresponding to the start node and a preset learning rate, and subtracting the product from a parameter of the current-time local model of the start node to obtain an updated current-time local model of the start node, thereby when the local joint processing (i.e., current-time local joint processing) does not correspond to the preset number of times, using the updated current-time local model for next local joint processing.

In an embodiment, the step of uploading, by each user terminal, the locally-updated model parameter for the current-round training to the server for aggregation, includes:
uploading, by each user terminal, the locally-updated model parameter for the current-round training to the server; and obtaining, by the server, an average value of the locally-updated model parameters of the user terminals as a parameter of the current-round updated global model.

In an embodiment, the server is a base station in a cellular network, and each user terminal is a user terminal device in the cellular network.

In a second aspect, an embodiment of the disclosure provides a face recognition method based on adaptive split learning-federated learning, applied to a target terminal, the face recognition method includes the following steps:
acquiring a trained face recognition model and an image to be recognized; where the trained face recognition model is obtained through the model training method according to the first aspect, and the target terminal is the server or one of the user terminals in the RingSFL system; and
inputting the image to be recognized into the trained face recognition model to obtain a face recognition result; where the face recognition result includes attribute information of a face in the image to be recognized, and the attribute information includes identity information.

The disclosure has at least the following beneficial effects.

According to the embodiments of the disclosure, in the process of training a face recognition model, the model training method retains the ability of FL to utilize distributed computing in the whole training process, so that the computation efficiency and convergence speed can be improved. The server allocates the respective propagation step length to each user terminal based on the device information of all user terminals, which realizes the allocation of computation loads to the user terminals according to the characteristics of different user terminals, so it can better adapt to the heterogeneity of the system, significantly alleviate the laggard effect and improve the training efficiency of the system. At the same time, it is difficult for eavesdroppers to recover data from the mixed model because each user terminal only transmits its own output layer gradient in the backward propagation, so the privacy protection performance of data can be enhanced.

The face recognition method provided by the embodiment of the disclosure is realized by using the face recognition model trained by the provided model training method, is suitable for various face recognition scenes, and has the advantage of high recognition accuracy.

The disclosure will be further described in detail with accompanying drawings and specific embodiments.

### BRIEF DESCRIPTION OF DRAWINGS

FIG. 1 illustrates a schematic flowchart of a model training method based on adaptive split learning-federated learning according to an embodiment of the disclosure.

FIG. 2 illustrates a schematic structural diagram of a RingSFL system according to an embodiment of the disclosure.

FIG. 3 illustrates a schematic diagram of forward propagation of a ring topology according to an embodiment of the disclosure.

FIG. 4 illustrates a schematic diagram of forward propagation of a ring topology according to an embodiment of the disclosure.

FIG. 5 illustrates a schematic diagram of backward propagation for the ring topology illustrated in FIG. 3 according to an embodiment of the disclosure.

FIG. 6 illustrates an experimental result diagram of the model training method based on adaptive split learning-federated learning aiming at the influence of different eavesdropping probability and the number of user terminals on privacy leakage probability according to an embodiment of the disclosure.

FIG. 7 illustrates a schematic diagram showing relationship curves between the test accuracy and the computation time in the training process of RingSFL and the existing methods.

FIG. 8 illustrates a schematic diagram showing relationship curves between the convergence and the number of training rounds of RingSFL and the existing methods.

FIG. 9 illustrates a schematic diagram showing a comparison of convergence performance between RingSFL and the existing methods at different D2D communication link rates.

FIG. 10 illustrates a schematic flowchart of a face recognition method based on adaptive split learning-federated learning according to an embodiment of the disclosure.

### DETAILED DESCRIPTION OF EMBODIMENTS

The following will provide a clear and complete description of the technical solutions in the embodiments of the disclosure, in conjunction with the accompanying drawings. Apparently, the described embodiments are only a part of the embodiments of the disclosure, not all of the embodiments. Based on the embodiments in the disclosure, all other embodiments obtained by those skilled in the art without creative labor fall within the scope of protection of the disclosure.

In the related art, in order to improve efficiency and security of a distributed learning system, O. Gupta et al. put forward split learning (SL), a core idea of which is to split a network structure, each device only keeps a part of the network structure (i.e., sub-network structure), and sub-network structures of all devices form a complete network model. In the training process, each device only performs forward or backward computation on a local network structure, and transmits a computation result to a next device. The devices complete the model training through an intermediate result of a joint network layer until the model converges. However, this scheme needs to transmit labels, and there is still the risk of data leakage. By integrating respective advantages of FL and SL, the embodiment of the disclosure proposes a method to solve a heterogeneity problem in training a face recognition model only by relying on a learning mechanism itself, which can be called RingSFL for short. Where Ring represents a ring topology and SFL represents SL+FL. The following is a specific explanation.

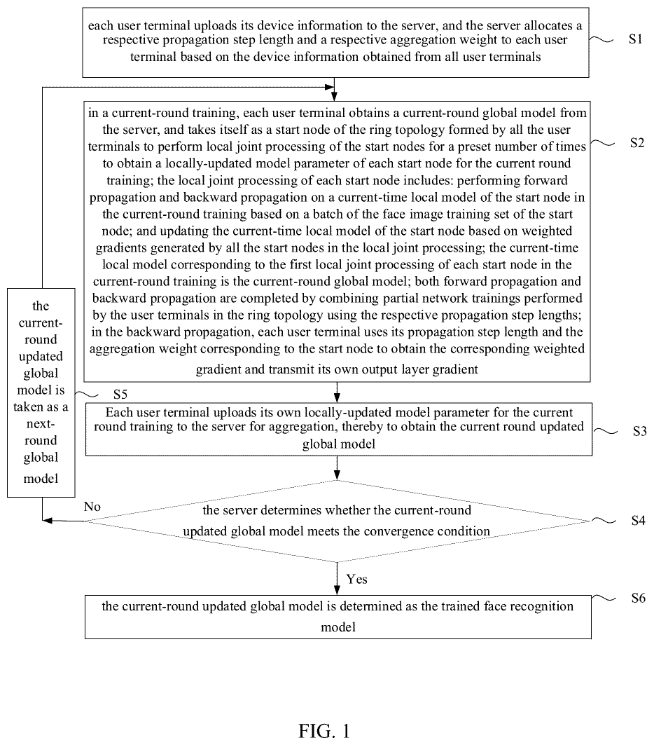

In the first aspect, an embodiment of the disclosure provides a model training method based on adaptive split learning-federated learning, which is applied to a RingSFL system including a server and multiple user terminals. Please refer to FIG. 1 for the process of this method, which specifically includes the following steps S1 to S6.

S1, each user terminal uploads its device information to the server, and the server allocates a respective propagation step length and a respective aggregation weight to each user terminal based on the device information obtained from all user terminals.

Specifically, the propagation step length represents the number of propagation network layers. The aggregation weight is used for subsequent gradient weighting computation, and meanings and functions of the propagation step length and the aggregation weight are described in detail later.

In the embodiment of the disclosure, the server and the user terminals can establish the RingSFL system in advance in an agreed way. The RingSFL system includes multiple devices existing in a network. For example, in an alternative embodiment, the server can be a base station in a cellular network, and each user terminal can be a user terminal device in the cellular network. Of course, an applicable network form of the RingSFL system is not limited to the cellular network.

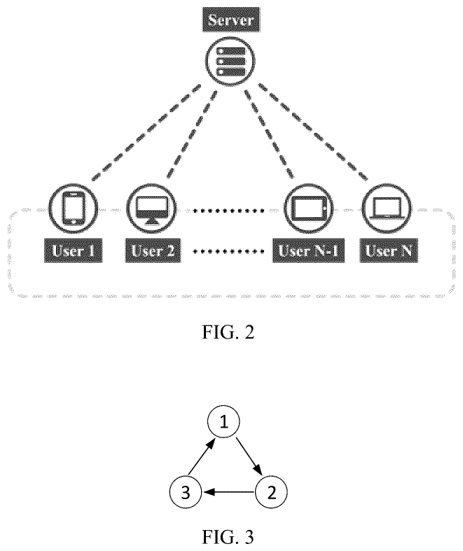

FIG. 2 illustrates an architectural form of the RingSFL system. The RingSFL system has the same structure as FL, including a server for model aggregation (represented by Server in FIG. 2) and a user terminal set for cooperative training. The server can be a central server. There are N numbers of the user terminals in the user terminal set (represented by User in FIG. 2), and each user terminal can be a user terminal device, such as a mobile phone, a desktop computer and a notebook computer. In the RingSFL system, multiple user terminals can form a ring topology, as illustrated in a dotted box in FIG. 2, in which adjacent user terminals can communicate with each other through the direct communication technology, such as the device-to-device (D2D) communication technology. Each user terminal can also communicate with the server like FL to download models and upload parameters.

A face recognition task scene targeted by a trained model in the embodiment of the disclosure may be to use a trained face recognition model to perform operations related to identity confirmation for users in a specific area. For example, users can confirm their identity through face recognition, and then they can start related devices in a specific area to realize access control, punching cards, face-brushing shopping and so on. The specific area can be campus, community, or some confidential units and so on.

Each user terminal has a face image training set. The face image training set includes multiple face images as training samples and corresponding sample labels. Each sample label includes attribute information corresponding to the face in the corresponding training sample, such as location information, identity information, etc.

In an alternative embodiment, S1 may include S11 to S14.

S11, each user terminal uploads its computation capability value and the number of the training samples corresponding to its face image training set to the server.

Each user terminal knows its own computation capability value. For an i-th user terminal uᵢ (1≤i≤N) in the RingSFL system, its computation capability value can be expressed as Cᵢ, the higher the value of Cᵢ, the stronger the computation capability of uᵢ. The number of the training samples corresponding to the face image training set of uᵢ can be expressed as Dᵢ.

The user terminals can upload their respective computation capability values and the numbers of the training samples corresponding to their own face image training sets to the server in parallel.

S12, the server calculates the propagation step length of each user terminal by using a pre-established propagation step length computation formula based on the obtained computation capability values of the user terminals.

Specifically, the propagation step length computation formula is determined according to a pre-established optimization problem regarding computation time.

In the embodiment of the disclosure, because the computation capability values of the user terminals are different, the server needs to allocate a computation load of each user terminal according to the computation capability values of the user terminals, so as to better adapt to the heterogeneity of the system. Therefore, before S1, the embodiment of the disclosure constructs the optimization problem regarding computation time in advance. The corresponding analysis process is as follows.

In order to minimize model training time and determine split points of the model, the embodiment of the disclosure designs a model split scheme in the RingSFL system. The computation load of each user terminal should be determined according to its computation capability.

A cutting ratio (i.e., split ratio) of the user terminal uᵢ is defined as pᵢ, which represents a computation load rate allocated to the user terminal uᵢ. For all user terminals,

$${\sum }_{i = 1}^{N} {p}_{i} = 1. \qquad C = {\sum }_{i = 1}^{N} {C}_{i}$$

is used to represent a total computation capability value of all user terminals in the RingSFL system. cᵢ is introduced to re-express the computation capability value of uᵢ as cᵢC, where

$${c}_{i} = \frac{{C}_{i}}{C} , {c}_{i}$$

represents a ratio of the computation capability value of uᵢ to the total computation capability value.

M is used to represent a total amount of computation required for the user terminal as a start node to complete a local joint processing by using a batch of its own face image training set in the ring topology (please refer to the following for the local joint processing). A unit of the total amount of computation is giga floating point operations per second (GFLOPS), and the value is a definite value relative to known tasks and training data. The amount of computation of uᵢ in this batch training is pᵢMN, and then the computation time consumed to complete this batch training by uᵢ is

$$\frac{{p}_{i} M N}{{c}_{i} C} .$$

The embodiment of the disclosure finds in the experiment that although some user terminals have high computation capability, they have become laggards in training because of the excessive amount of computation allocated to them. Therefore, the duration of system training batch is limited by the user terminal with the longest training time, and the computation load should be optimized to suppress the laggard effect, so as to minimize the training time.

Because there are the N numbers of user terminals in the system, the computation time consumed by the laggard to train a batch is

$$max \{ \frac{{p}_{1} M N}{{c}_{1} C} , \frac{{p}_{2} M N}{{c}_{2} C} , … , \frac{{p}_{N} M N}{{c}_{N} C} \}$$

. In order to minimize the computation time of the laggard, the embodiment of the disclosure formulates the optimization problem regarding computation time.

The optimization problem regarding computation time includes:

$${min}_{{p}_{1} , … , {p}_{N}} max \{ \frac{{p}_{1} M N}{{c}_{1} C} , \frac{{p}_{2} M N}{{c}_{2} C} , … , \frac{{p}_{N} M N}{{c}_{N} C} \}$$

$$s . t .$$

$${\sum }_{i = 1}^{N} {p}_{i} = 1 , ∀ i = 1 , … , N$$

$$0 \leq {p}_{i} \leq 1 , ∀ i = 1 , … , N$$

where pᵢ represents the cutting ratio, which indicates the computation load rate allocated to the i-th user terminal uᵢ; N represents the number of the user terminals, Cᵢ represents the computation capability value of the user terminal uᵢ;

$$C = {\sum }_{i = 1}^{N} {C}_{i}$$

represents the total computation capability value of all user terminals; cᵢ represents the ratio of the computation capability value of uᵢ to the total computation capability value; M represents the total amount of computation required for the start node to complete the local joint processing; max {□} represents obtaining the maximum value; and

$${min}_{{p}_{1} , … , {p}_{N}}$$

represents minimization.

The optimization problem is solved by introducing a new variable m. The solution result of the optimization problem regarding computation time includes:

$$\{ \begin{matrix}{p}_{i}^{*} = {c}_{j} , ∀ i = 1 , … , N \\ {m}^{*} = \frac{M N}{C}\end{matrix}$$

where p*ᵢ represents an optimal cutting ratio of the user terminal uᵢ; m represents the optimization result of the variable m introduced in the process of solving the optimization problem.

From the solution result of the above optimization problem, it can be seen that the optimal value of pᵢ should be equal to the ratio cᵢ of the computation capability value of uᵢ to the total computation capability value. As the embodiment of the disclosure finds in the experiment that the laggard effect can be significantly alleviated through optimization of p ᵢ, Lᵢ=p*ᵢw is set to reduce the training time. That is to say, the propagation step length computation formula is expressed as follows:

$${L}_{i} = {p}_{i}^{*} w = \frac{{C}_{i}}{{\sum }_{j = 1}^{N} {C}_{j}} w$$

where Lᵢ represents the propagation step length of uᵢ; and w represents the total number of layers of the original network corresponding to each round global model.

In the training process of the same model, the original network corresponding to each round global model adopts the same known network, so the total number w of layers of the original network is a known fixed value. For example, the original network can adopt any existing neural network for target classification, such as convolutional neural network (CNN), you only look once (YOLO) series or visual geometry group network (VGG16).

It should be noted that the optimal cutting ratio p*ᵢ of the user terminal uᵢ may not be an integer, so p*ᵢw may not be an integer in general. Therefore, the server may need to round the obtained non-integer Lᵢ, which can be rounded up or down.

S13, the server calculates the total number of the training samples of all user terminals, and determines a ratio of the number of training samples of each user terminal to the total number of training samples as the aggregation weight of the corresponding user terminal.

Specifically, the aggregation weight calculated by the server for the user terminal uᵢ can be expressed as aᵢ:

$${a}_{i} = \frac{{D}_{i}}{{\sum }_{j = 1}^{N} {D}_{j}}$$

S14, the server sends the respective propagation step length and the respective aggregation weight to each user terminal.

In the same way, the server can send the respective propagation step length and the respective aggregation weight to each user terminal in parallel. At this point, the initialization process of propagation step length and aggregation weight required for training is completed. Because the computation capability value of each user terminal and the number of training samples corresponding to the face image training set of each user terminal are relatively fixed, the propagation step length and the aggregation weight of each user terminal remain unchanged in the subsequent training process.

Compared with the existing FL, the server of the embodiment of the disclosure adds the allocation step of propagation step length and aggregation weight to each user terminal, and the propagation step length of each user terminal is obtained by the server allocating the computation load according to the characteristics of different users' computation capability, so it can better adapt to the heterogeneity of the system, significantly alleviate the laggard effect and improve the training efficiency of the system.

S2, in a current-round training, each user terminal obtains a current-round global model from the server, and takes itself as a start node of the ring topology formed by all the user terminals to perform local joint processing of start nodes respectively corresponding to the user terminals for a preset number of times to obtain a locally-updated model parameter of each start node for the current-round training.

The local joint processing of each start node includes: performing forward propagation and backward propagation on a current-time local model of the start node in the current-round training based on a batch of the face image training set of the start node; and updating the current-time local model of the start node based on weighted gradients generated by all the start nodes in the local joint processing. The current-time local model corresponding to the first local joint processing of each start node in the current-round training is the current-round global model. Both forward propagation and backward propagation are completed by combining partial network trainings (also referred to as partial network training continuation) performed by the user terminals in the ring topology using their respective propagation step lengths. In the backward propagation, each user terminal uses its propagation step length and the aggregation weight corresponding to the start node to obtain the corresponding weighted gradient and transmit its output layer gradient.

At the beginning of each round training, all user terminals obtain the same current-round global model from the server and set it as their first local model in the current-round training. With the progress of each local joint processing, the “current-time local model” in this round training is constantly updated. For the first round training, the current-round global model is the original network, such as VGG16 mentioned above.

For each user terminal, the number of training samples in its own face image training set is often large, so it is unrealistic to input all the training samples into the model at one time in each round training. In order to improve the training effect, a current general model training method of ML is to divide the training set into multiple batches, and the batches are input into the model in turn for training. Therefore, in each round training, each user terminal performs local joint processing for the preset number of times, each local joint processing is completed by using an unused batch in the face image training set corresponding to each user terminal, and the local joint processing of the user terminals is carried out synchronously. In the embodiment of the disclosure, the specific value of the preset number is determined in advance according to the number and batch size of the training samples in the face image training set.

For each user terminal, each local joint processing of the user terminal can be divided into three stages: forward propagation, backward propagation and parameter update. The local joint processing of the user terminal is completed by all user terminals, and the parameter update stage needs to use the results of the local joint processing of all user terminals.

In the following, taking the local joint processing conducted by the user terminal as the start node of the ring topology in a round of training as an example, the three stages of forward propagation, backward propagation and parameter update are explained respectively.

### I. Forward Propagation

For each start node, in the local joint processing of the start node, the process of the forward propagation includes the following steps.

The start node uses a current batch of the face image training set to propagate forward at least one layer corresponding to the propagation step length of the start node from a first layer of the current-time local model, and transmits a feature map output by a local network corresponding to its forward propagation and a serial number of its output layer (i.e., output layer serial number) to a next user terminal along the forward direction of the ring topology starting from the start node.

For each forward current node that traverses sequentially along the forward direction of the ring topology, the forward current node takes a next layer corresponding to an output layer serial number of a previous user terminal along the forward direction of the network as the start layer of the forward current node, propagates forward at least one layer corresponding to the propagation step length of the forward current node by using a computation result transmitted by a previous user terminal from the start layer of the forward current node, and transmits a computation result obtained by a local network corresponding to its forward propagation to a next user terminal along the forward direction of the ring topology. The forward current node is the user terminal traversed except the start node in the ring topology, and the end node is the last user terminal traversed in the ring topology. In addition to the end node, each forward current node also transmits its own output layer serial number to the next user terminal, and the computation result is the feature map output by the corresponding local network. The computation result of the end node is the face recognition result.

The start node compares the face recognition result transmitted by the end node with a sample label in the current batch of the face image training set to obtain a comparison result, and calculates a network loss value corresponding to the start node according to the comparison result.

For convenience of understanding, the embodiment of the disclosure takes a ring topology formed by three user terminals as an example. Please refer to FIG. 3, which is a schematic diagram of forward propagation of the ring topology provided by the embodiment of the disclosure. The circle in FIG. 3 indicates the user terminal, and the serial number indicates the identification number of the user terminal.

There are three user terminals u₁, u₂, u₃ in FIG. 3, which form the ring topology, u₁ is the start node and u₃ is the end node in the forward propagation.

Specifically, u₁ uses a current batch of the face image training set to propagate L₁ layers forward in the forward direction of the network starting from the first layer of the current-time local model. Since the total number of layers of the current-time local model is the same as that of the original network, that is w, the input layer of the propagated local network by u₁ is the first layer of the current-time local model, and the output layer is the L₁-th layer of the current-time local model. In the process of the forward propagation of u₁, the current batch of the face image training set is input to the input layer of the local network, and its output layer outputs a feature map ƒ₁, and u₁ transmits the feature map and its output layer serial number (ƒ₁, L₁) to u₂. For the first local joint processing in the first round training, the current-time local model is the original network.

The input layer of the local network of u₂ is the (Lᵢ+1)-th layer of the current-time local model, and u₂ inputs ƒ₁ into its input layer and propagates the L₂ layers forward along the forward direction of the network. The output layer of the local network of u₂ is the (L₁+L₂)-th layer of the current-time local model, the output layer of the local network of u₂ outputs a feature map ƒ₂, and u₂ transmits (ƒ₂, L₁+L₂) to u₃.

The input layer of the local network of u₃ is the (L₁+L₂+1)-th layer of the current-time local model. u₃ inputs ƒ₂ into its input layer and propagates the L₃ layers forward along the forward direction of the network. The output layer of the local network of u₃ is the (L₁+L₂+L₃)-th layer of the current-time local model. In practice, due to the large number of user terminals, the output layer of the end node of the ring topology is the output layer of the current-time local model. The output layer of the local network of u₃ outputs the face recognition result ƒ₃, which will be transmitted to u₁.

u₁ compares the face recognition result f, with the sample label in the current batch. It is understandable that the face recognition result represents a predicted value, and the sample label records a true value. The network loss value can be calculated from the difference between the predicted value and the true value, that is, the corresponding loss₁ of u₁ can be obtained. The process of calculating the loss value can be understood by referring to the existing neural network training process, and will not be explained in detail here.

Thus, the forward propagation with u₁ as the start node of the ring topology is completed.

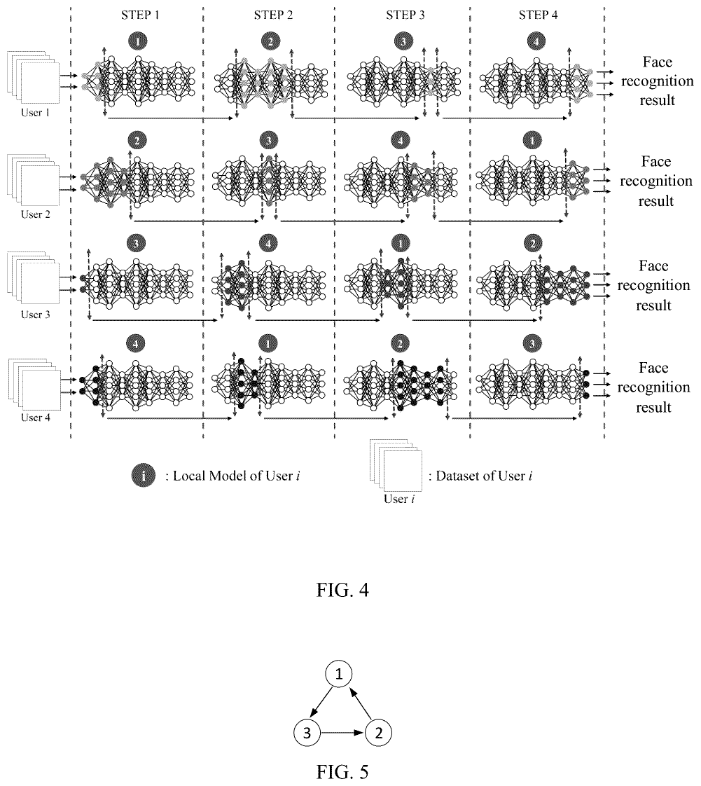

In the process of the forward propagation of u₁ with itself as the start node of the ring topology, u₂ and u₃ also perform forward propagation with themselves as the start nodes of the ring topology to obtain loss₂ and loss₃ respectively. The specific process of the forward propagation of u₂ and u₃ is similar to that of the forward propagation of u₁ with itself as the start node of the ring topology. For the forward propagation carried out by multiple user terminals in parallel, please refer to FIG. 4, which is a schematic diagram of the forward propagation of the ring topology provided by the embodiment of the disclosure. In FIG. 4, four user terminals jointly train a 9-layer multilayer perceptron (MLP).

In FIG. 4, each row represents the forward propagation process of the corresponding user terminal, in which the circular serial numbers represent the local models of different user terminals, that is, their corresponding local networks. Taking User1 as the start node as an example, the whole forward propagation process is jointly completed by User1, User2, User3 and User4, and each user terminal corresponds to a STEP stage. It can be seen that each user terminal uᵢ only starts to propagate Lᵢ layers forward from different layers of the current-time local model. In FIG. 4, the network layers propagated in each STEP stage are displayed in a darker color, and the network layers propagated by each user terminal in multiple STEP stages are successive, and the output layer of the last user terminal outputs the face recognition result, and FIG. 4 shows the chromaticity differentiation of the network layers propagated in different rows.

### II. Backward propagation

For each start node, in the local joint processing of the start node, the process of backward propagation includes the following steps.

Each start node transmits its network loss value and its own aggregation weight to the corresponding end node.

The end node uses the network loss value to backward propagate at least one layer corresponding to the propagation step length of the end node from the last layer of the current-time local model, calculates the local network gradient corresponding to the backward propagation of the end node, multiplies the obtained local network gradient with the aggregation weight of the start node to obtain the weighted gradient corresponding to the end node and stores it; and the end node transmits the calculated output layer gradient and its output layer serial number of the local network corresponding to the end node to the next user terminal along the backward direction of the ring topology.

For each backward current node that traverses sequentially along the backward direction of the ring topology, the backward current node takes the next layer corresponding to the output layer serial number of the previous user terminal along the backward direction of the network as the start layer of the backward current node, uses the output layer gradient transmitted by the previous user terminal to backward propagate at least one layer corresponding to the propagation step length of the backward current node from the start layer of the backward current node, calculates the local network gradient corresponding to its backward propagation, and multiplies the obtained local network gradient with the aggregation weight of the start node to obtain the weighted gradient corresponding to the backward current node and stores the weighted gradient corresponding to the backward current node, and transmits the calculated output layer gradient and its output layer serial number of the local network corresponding to the backward current node to the next user terminal along the backward direction of the ring topology. Each backward current node is the user terminal traversed except the start node and the end node in the ring topology. The start node takes the next layer corresponding to the output layer serial number of the previous user terminal along the backward direction of the network as the start layer of the start node, uses the output layer gradient transmitted by the previous user terminal to backward propagate at least one layer corresponding to the propagation step length of the start node from the start layer of the start node, calculates the local network gradient corresponding to the backward propagation, multiplies the obtained local network gradient with the aggregation weight of the start node to obtain the weighted gradient corresponding to the start node and stores it.

For the convenience of understanding, the disclosure will continue to be described by taking the ring topology of FIG. 3 as the example. Please refer to FIG. 5, which is a schematic diagram of the backward propagation provided by the embodiment of the disclosure for the ring topology of FIG. 3. It can be seen that the communication direction of the user terminals is reversed compared with the forward propagation. The specific backward propagation includes the following steps.

The start node u₁ transmits loss₁ and a₁ to the end node u₃.

u₃ uses loss₁ to propagate the L₃ layers from the last layer of the current-time local model used for the forward propagation in the backward direction of the network. Since the total number of layers of the current-time local model is w, the input layer of the local network propagated by u₃ at this time is the last layer of the current-time local model, and the output layer is the (w−L₃+1)-th layer of the current-time local model. In the backward propagation process of u₃, the gradient of the propagated L₃ layers is calculated to obtain the local network gradient G_{3,1} of u₃, where the first subscript 3 of G_{3,1} represents the identification number of the current user terminal traversed, and the second subscript 1 of G_{3,1} represents that the current local joint processing is performed by u₁ as the start node, and the product (G_{3,1}×a₁) of the calculated local network gradient G_{3,1} and a₁ is used as the weighted gradient of u₃, which is stored for subsequent parameter update. At the same time, the output layer gradient g₃ is calculated and the output layer gradient together with the output layer serial number (g₃, w−L₃+1) of u₃ are sent to u₂.

The input layer of the local network of u₂ is the (w−L₃)-th layer of the current-time local model, u₂ uses g₃ to propagate the L₂ layers from its input layer in the backward direction of the network, the output layer of the local network of u₂ is the (w−L₃−L₂+1)-th layer of the current-time local model. In the process of backward propagation of u₂, the gradient of the propagated L₂ layers is calculated to obtain the local network gradient G_{2,1} of u₂, and the product (G_{2,1}×a₁) of the calculated local network gradient G_{2,1} and a₁ is used as the weighted gradient of u₂, which is stored for subsequent parameter update. At the same time, the output layer gradient g₂ of u₂ is calculated and the output layer gradient together with the output layer serial number (g₂, w−L₃−L₂+1) of u₂ are sent to u₁.

The input layer of the local network of u₁ is the (w−L₃−L₂)-th layer of the current-time local model, u₁ uses g₂ to propagate the L₁ layers in the backward direction of the network from its input layer, and the output layer of the local network of u₁ is the (w−L₃−L₂−L₁+1)-th layer of the current-time local model. In practice, due to the large number of user terminals, the output layer of the local network of the start node of the ring topology is the first layer of the current-time local model. In the process of backward propagation of u₁, the gradient of the propagated L₁ layers is calculated to obtain the local network gradient G_{1,1} of u₁ and the product (G_{1,1}×a₁) of the calculated local network gradient G_{1,1} and a₁ is used as the weighted gradient of u₁, which is stored for subsequent parameter update. For the last user terminal in the backward propagation, there is no need to calculate and transmit the output layer gradient of u₁ at this time.

Thus, the corresponding backward propagation of u₁ is completed. It can be understood that after the forward propagation and the backward propagation of u₁ with itself as the start node of the ring topology, each user terminal is stored with the corresponding weighted gradient, that is, in the corresponding backward propagation of u₁, the weighted gradient of u₃ is (G_{3,1}×a₁), the weighted gradient of u₂ is (G_{2,1}×a₁), and the weighted gradient of u₁ is (G_{1,1}×a₁).

In the process of the forward propagation and the backward propagation of u₁ with itself as the start node of the ring topology, u₂ and u₃ also perform the forward propagation and the backward propagation with themselves as the start nodes of the ring topology. After the backward propagation, weighted gradients are also stored, and the specific process of the backward propagation of u₂ and u₃ is similar to that of the backward propagation of u₁. It can be understood that in the corresponding backward propagation process of u₂, the weighted gradient of u₁ is (G_{1,2}×a₂), the weighted gradient of u₃ is (G_{3,2}×a₂), and the weighted gradient of u₂ is (G_{2,2}×a₂). In the corresponding backward propagation process of u₃, the weighted gradient of u₂ is (G_{2,3}×a₁), the weighted gradient of u₁ is (G_{1,3}×a₃), and the weighted gradient of u₃ is (G_{3,3}×a₃).

### III. Parameter Update

The current-time local model of each start node is updated based on the weighted gradients generated by all the start nodes in the local joint processing process, which includes the following steps.

1) A sum of the weighted gradients corresponding to each user terminal (i.e., each start node) is calculated from all the weighted gradients generated in the local joint processing performed by all the start nodes.

Continuing to explain from the previous example, after u₁, u₂, u₃ are respectively used as the start nodes of the ring topology for the forward propagation and the backward propagation, the weighted gradients obtained are as shown above. Then, by summing the weighted gradients stored at each user terminal during different backward propagation processes, the sum of the weighted gradients of each user terminal can be obtained.

Thus, the sum of the weighted gradient corresponding to u₁ is (G_{1,1}×a₁)+(G_{1,2}×a₂)+(G_{1,3}×a₃); the sum of the weighted gradient corresponding to u₂ is (G_{2,1}×a₁)+(G_{2,2}×a₂)+(G_{2,3}×a₃); and the sum of the weighted gradient corresponding to u₃ is (G_{3,1}×a₁)+(G_{3,2}×a₂)+(G_{3,3}×a₃).

2) For each user terminal, a product of the sum of the weighted gradients corresponding to the user terminal and a preset learning rate is calculated, and the product is subtracted from the parameter of the current-time local model of the user terminal to obtain the updated current-time local model of the user terminal, and the updated current-time local model is used for the next local joint processing when the current-time local joint processing does not correspond to the preset number of times (that is, the number of the performed local joint processing does not reach the preset number).

In the embodiment of the disclosure, the preset learning rate is a preset numerical value, which can be expressed by η, and the value of η can be 0.1 and so on.

For each user terminal, the difference between the parameter of the current-time local model of the user terminal and the product of the sum of the weighted gradients corresponding to the user terminal and the preset learning rate is the parameter of the updated current-time local model. After setting it into the current-time local model, the updated current-time local model of the user terminal can be obtained.

After the local joint processing is finished for each user terminal, it is determined whether the total number of local joint processing completed at present reaches the preset number, and in response to the total number of local joint processing completed at present fails to reach the preset number, the updated current-time local model is used as the “current-time local model” for the next local joint processing to continue the local joint processing. In response to the total number of local joint processing completed at present reaching the preset number, the current-round training of the user terminal is ended, and the parameter of the updated current-time local model of the user terminal is uploaded to the server as the local updated model parameter for the current-round training.

S3, each user terminal uploads its own locally-updated model parameter for the current-round training to the server for aggregation, thereby to obtain the updated global model for the current-round.

This step is to complete model aggregation, which refers to the process that the server receives the training results uploaded by the user terminals and aggregates them. Among them, the model parameters uploaded by the user terminals essentially represent mixed models.

In an alternative embodiment, each user terminal uploads its own locally-updated model parameter for the current-round training to the server for aggregation, including the following steps: each user terminal uploads its own locally-updated model parameter for the current-round training to the server, and the server calculates the average value of the received locally-updated model parameters as the current-round updated global model parameter.

After the round of training, the user terminals can upload their locally-updated model parameters for the current-round training to the server in parallel. The serve can obtain the current-round updated global model parameter and set the current-round updated global model parameter into the current-round global model to obtain the current-round updated global model.

In order to illustrate the effectiveness of the polymerization scheme of the embodiment of the disclosure, it is analyzed and expounded below. Because of the existence of the mixed model, the traditional federated averaging (FedAvg) algorithm of the model aggregation cannot be used directly. Therefore, the embodiment of the disclosure provides a revised model aggregation scheme in the RingSFL system.

Different from FedAvg, the weighting in the RingSFL system is realized by each user terminal during training. The aggregation weight of uᵢ is transmitted between the user terminals with the backward propagation, and multiplied by the calculated local network gradient, which is the weighted gradient stored by each user terminal.

W^{(r)}=[L₁^{(r)}, . . . , Lₖ^{(r)}, . . . , L_{W}^{(r)})] represents a current-round global model of the r-th round training for each user terminal, where Lₖ^{(r)} represents a k-th layer of W^{(r)}. Because more than one user terminal can train each layer model of uᵢ, the gradients of the user terminals can be accumulated in each layer model of uᵢ. U_{i,k} represents a user terminal set at the k-th layer of the trained model of uᵢ,

$${⋃}_{i = 1}^{N} {U}_{i , k} = \{ 1 , … , N \} .$$

where g_{i,k} represents the gradient of the k-th layer calculated by using the training samples of uᵢ. aᵢ represents the aggregation weight of uᵢ, and η represents a preset learning rate. The model obtained by server aggregation can be expressed as follows:

$${W}^{( r + 1 )} = \frac{1}{N} {\sum }_{i = 1}^{N} {W}_{i}^{( r + 1 )}$$

where W^{(r+1)} represents the updated global model parameter obtained by the server for the r-th round training after the model is aggregated, that is, the parameter of the “current-round updated global model” to be used in the (r+1)-th round training; Wᵢ^{(r+1)} represents the locally-updated model parameter uploaded by the user terminal uᵢ to the server for the r-th round training.

Analysis of the above formula is as follows:

$$\begin{matrix}{W}^{( r + 1 )} = [ … , {L}_{k}^{( r )} - \frac{η}{N} {\sum }_{i = 1}^{N} {a}_{i} {g}_{i , k} , … ] \\ = {W}^{( r )} - \frac{η}{N} {\sum }_{i = 1}^{N} {a}_{i} [ … , {g}_{i , k} , … ] \\ = {W}^{( r )} - \frac{η}{N} {\sum }_{i = 1}^{N} {a}_{i} {g}_{\sum i}\end{matrix}$$

where g_{Σi} represents gradients of all layers calculated using the training samples of uᵢ, that is, the sum of all the elements in the set [ . . . , g_{i,k}, . . . ].

It can be seen that the weighting of the gradients in the embodiment of the disclosure is realized by the user terminal during the backward propagation, and the server only needs to average the locally-updated model parameters uploaded by the user terminals for the current-round training.

It should be noted that the aggregation scheme of the embodiment of the disclosure will reduce the learning rate. Therefore, in order to compare the aggregation effect with the existing algorithm, such as FedAvg, at the same learning rate, it is necessary to expand the learning rate of the embodiment of the disclosure by a certain multiple to ensure the convergence performance. For example, compared with the learning rate of the existing algorithm of 0.01, the embodiment of the disclosure can set the learning rate to 0.1, or in an alternative embodiment, the learning rate can be set as the product of the traditional learning rate and the number of participating user terminals.

Through verification, under the same learning rate, the polymerization result of the embodiment of the disclosure is similar to that of FedAvg, and the polymerization effect is basically the same.

S4, the server determines whether the current-round updated global model meets the convergence condition.

Specifically, the server can input the test samples stored by itself in the face image test set into the current-round updated global model to obtain the corresponding prediction result of face recognition. When the difference between the prediction result and the sample label of the input sample is less than a certain threshold, it can be determined that the current-round updated global model meets the convergence condition.

When the difference between the prediction result and the sample label of the input sample is not less than the certain threshold, S5 is executed, that is, the current-round updated global model is taken as a next-round global model, and the step of obtaining the current-round global model from the server by each user terminal in the current-round training is returned to perform.

Specifically, when the current-round updated global model does not meet the convergence condition, it returns to S2 for the next-round training, and the “next-round global model” obtained in S5 will be the “current-round global model” in S2 after returning to S2 to start the next-round training.

When the global model meets the convergence condition, S6 is executed, that is, the current-round updated global model is determined as the trained face recognition model.

Specifically, when the current-round updated global model meets the convergence condition, the training is ended and the current-round updated global model is determined as the trained face recognition model. Furthermore, the server can also send the trained face recognition model to the required user terminal.

In the process of face recognition model training, the model training method based on adaptive split learning-federated learning provided by the embodiment of the disclosure retains the ability of FL to utilize distributed computing in the whole training process, so that the computation efficiency and convergence speed can be improved. The server allocates the respective propagation step length to each user terminal based on the device information of all user terminals, which realizes the allocation of computation loads to the user terminals according to the characteristics of different user terminals, so it can better adapt to the heterogeneity of the system, significantly alleviate the laggard effect and improve the training efficiency of the system. At the same time, it is difficult for eavesdroppers to recover the data from the mixed model because each user terminal transmits only its own output layer gradient in the backward propagation, so the performance of data privacy protection can be enhanced.

Because the user's face image data involves identity characteristics and belongs to personal privacy, it is difficult for the server to grasp the personal face image data of all users. The embodiment of the disclosure can realize joint training by using local data by using the model training method based on adaptive split learning-federated learning, so that privacy can be ensured. When there are new users in a specific area, the user terminal can reuse the new sample data to update the model based on the original model obtained by training, which can greatly facilitate the face recognition task in a specific field and has a wide application prospect.

In order to verify the effect of the model training method based on adaptive split learning-federated learning in the embodiment of the disclosure, the experimental results are described below.

### I. Strong Privacy Protection Performance

1) For eavesdroppers, it is very difficult to recover user data from any partial or fragmented model, because it is necessary to obtain complete model parameters or gradients at present. In the method of the embodiment of the disclosure, the communication between the user terminals only includes the last layer output of each user terminal, and the model transmitted from each user terminal to the server is a mixed model. Because the eavesdropper does not know the cutting ratio, it is difficult for the eavesdropper to obtain the complete model parameters by eavesdropping. The only possible situation to recover user data by eavesdropping is when each user terminal only trains one network layer. By eavesdropping on all communication links in the system, it is possible for eavesdroppers to obtain the gradient of each layer in the model and piece together a complete model. After that, the embodiment of the disclosure verifies the possibility of privacy leakage in this case. The probability that the communication link between uᵢ and uᵢ₋₁ is eavesdropped is defined as e′ᵢ, and the probability that the communication link between u₁ and the server is eavesdropped is defined as eᵢ. Then, the privacy leakage probability of the user terminal uᵢ can be expressed as:

$${P}_{i} = {e}_{i} {\prod }_{j = 1 , … , N ; j \neq i} ( 1 - ( 1 - {e}_{i} ) ( 1 - {e}_{i}^{′} ) )$$

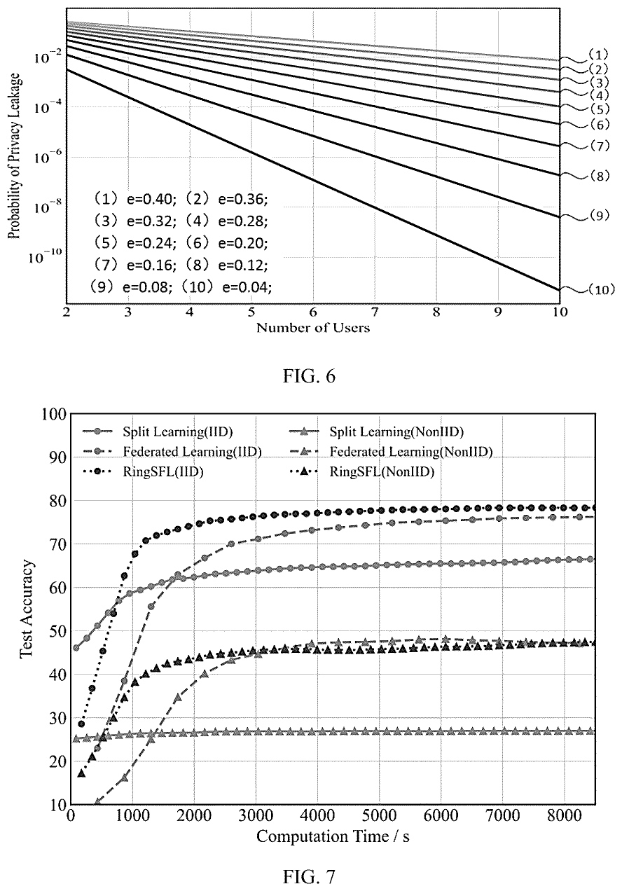

The influence of different eavesdropping probability and the number of user terminals on the privacy leakage probability is shown in FIG. 6. FIG. 6 illustrates an experimental result diagram of the model training method based on adaptive split learning-federated learning according to the embodiment of the disclosure, aiming at the influence of different eavesdropping probability and the number of user terminals on privacy leakage probability. It can be seen that with the increase of the number of user terminals, the probability of privacy leakage decreases exponentially. Even if the eavesdropping probability of each link is high, the leakage probability still drops rapidly to near zero. This means that when the number of user terminals in the RingSFL system is large enough, even in extreme cases (each user terminal only trains one layer at a time and has a high eavesdropping probability), the method of the embodiment of the disclosure can still ensure a sufficiently high security level.

2) For the malicious server, because the cutting rate of the model is known by the server, it is slightly less difficult for the server to recover the user terminal data than the eavesdropper. User terminals with high cutting rate usually have overlapping layers during training, and it is very challenging to recover the gradient of a single user terminal from the overlapping layers. However, there are no overlapping layers in some special cutting ratio settings, so it is possible for the server to recover data from the uploaded model. In order to solve this problem, the user terminal can negotiate with the server, and artificially make the system have overlapping layers to ensure security by appropriately shifting the cutting point.

### II. Higher Convergence Performance

The convergence performance of the embodiment of the disclosure can be further illustrated by simulation experiments.

### 1. Simulation Conditions

The experiment is carried out on four graphics processing units (GPU) (GEFORCE RTX 3090 24G) on a server. Each GPU simulates a user terminal participating in the training, while the server is simulated by a CPU (Intel® Xeon® Silver 4214R CPU @ 2.40 GHz). The software environment used in the experiment is Python 3.7.6. PyTorch 1.8.1+cu111 is used for model building and model training. In the experiment, CIFAR10 data set is used to simulate the training effect of the face image data set, and the original network used for training is the VGG16 model. In addition, in order to illustrate the influence of the distribution of data sets on RingSFL, all experiments are carried out on IID data sets and non-IID data sets respectively. In the experiment, the FL and SL algorithms are considered for comparison.

### 2. Simulation Results

This experiment compares the convergence performance of RingSFL with FL and SL and the influence of communication between the user terminals.

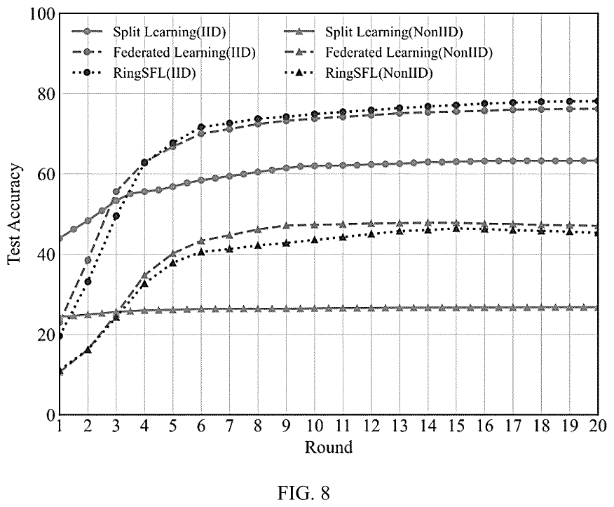

Please refer to FIG. 7, which illustrates the relationship curves of RingSFL and existing methods about test accuracy and computation time during training. In FIG. 7, compared with FL and SL, RingSFL achieves higher accuracy on IID data sets, almost the same accuracy on non-IID data sets, and the convergence speed is faster than that of the traditional FL.

Please refer to FIG. 8, which illustrates the relationship curves of RingSFL and existing methods about convergence and training rounds. In FIG. 8, RingSFL can achieve the same model accuracy as FL under the same number of training rounds. This shows that RingSFL can achieve the same accuracy as FL without more data samples.

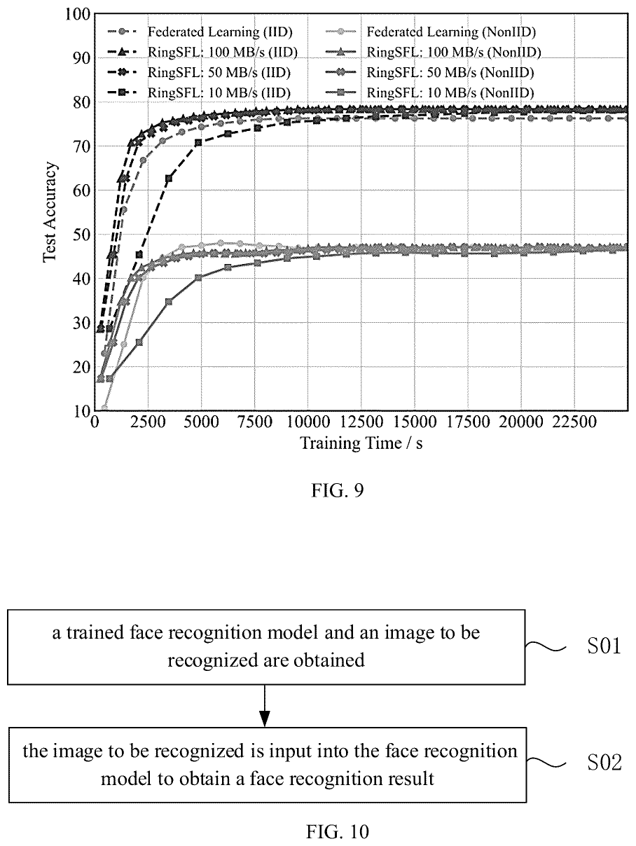

Please refer to FIG. 9, which illustrates the convergence performance comparison of RingSFL and existing methods at different D2D communication link rates. In FIG. 9, the communication link rate of D2D is set to 100 MB/s, 50 MB/s and 10 MB/s separately, while the communication link rate with the server is fixed to 50 MB/s. When the communication rates are 100 MB/s and 50 MB/s, it can be seen that RingSFL converges faster than FL. However, when the communication rate is 10 MB/s, the convergence speed of RingSFL is slow. This shows that RingSFL can have better convergence performance than the traditional FL when there is enough high rate link support (or using the small model).

To sum up, compared with the traditional FL, the model training method based on adaptive split learning-federated learning (RingSFL for short) proposed by the embodiment of the disclosure can be used to improve the security of the distributed learning system and achieve faster convergence without sacrificing the accuracy of the model. In addition, RingSFL can also be applied to scenes with obvious system heterogeneity to improve the overall system efficiency. Therefore, it can be effectively used to train neural network models such as face recognition models.

In the second aspect, an embodiment of the disclosure provides a face recognition method based on adaptive split learning-federated learning, which is applied to a target terminal, as shown in FIG. 10, and the method includes the following steps.

S01, a trained face recognition model and an image to be recognized are obtained.

Specifically, the face recognition model is trained according to the model training method based on adaptive split learning-federated learning in the first aspect. For the specific content of the model training method based on adaptive split learning-federated learning, please refer to the related description of the first aspect, and the description will not be repeated here.

The target terminal is the service or any user terminal in the RingSFL system. Or in an alternative embodiment, the target terminal can also be a trust server or a trust user terminal outside the RingSFL system. The so-called “trust” means that all parties have certain confidentiality agreements and there are no security risks such as privacy disclosure. Alternatively, the target terminal can also be a related device in a specific area corresponding to the RingSFL system, such as an access control device, a punching device, a face-brushing shopping device, etc.

The image to be recognized can be an image acquired or shot by the target terminal, which may contain a human face.

S02, the image to be recognized is input into the face recognition model to obtain a face recognition result.

The face recognition result includes attribute information of a human face in the image to be recognized. The attribute information includes identity information. For example, the identity information can include name, gender, age, ID number, job number, student number, etc., or it can also include the user's financial account information, etc.

The face recognition method based on adaptive split learning-federated learning provided by the embodiment of the disclosure is realized by using the face recognition model trained by the provided model training method based on adaptive split learning-federated learning, and the training process retains the ability of FL to utilize distributed computing, so that the convergence speed can be improved. It can better adapt to the heterogeneity of the system, improve the training efficiency of the system and enhance the privacy protection performance of data. This face recognition method is suitable for various face recognition scenes and has the advantage of high recognition accuracy.

What is claimed is:

1. A model training method based on adaptive split learning-federated learning, applied to a ring structured federated learning (RingSFL) system comprising: a server and a plurality of user terminals, and the model training method comprising:
uploading, by each user terminal, device information thereof to the server, and allocating, by the server, a respective propagation step length and a respective aggregation weight to each user terminal based on the device information obtained from the plurality of user terminals; wherein the propagation step length represents a number of propagation network layers;
in a current-round training, obtaining, by each user terminal, a current-round global model from the server, and taking, by each user terminal, itself as a start node of a ring topology formed by the plurality of user terminals to perform local joint processing of start nodes respectively corresponding to the plurality of user terminals for a preset number of times, thereby to obtain a locally-updated model parameter of each start node with respect to the current-round training; wherein the local joint processing of each start node comprises:
performing forward propagation and backward propagation on a current-time local model of the start node in the current-round training based on a batch of a face image training set of the start node; and
updating the current-time local model of the start node based on weighted gradients generated by the start nodes in the local joint processing; wherein a current-time local model corresponding to first local joint processing of each start node in the current-round training is the current-round global model; the forward propagation and the backward propagation are completed by combining partial network trainings respectively performed by the plurality of user terminals in the ring topology by using the respective propagation step lengths; and in the backward propagation, each user terminal obtains a corresponding one of the weighted gradients by using the propagation step length thereof and the aggregation weight corresponding to the start node, and transmits an output layer gradient thereof;
uploading, by each user terminal, the locally-updated model parameter for the current-round training to the server for aggregation, and obtaining a current-round updated global model;
determining, by the server, whether the current-round updated global model meets a convergence condition;
in response to the current-round updated global model failing to meet the convergence condition, taking the current-round updated global model as the current-round global model, and returning to perform the step of in the current-round training, obtaining, by each user terminal, the current-round global model from the server; and
in response to the current-round updated global model meeting the convergence condition, determining the current-round updated global model as a trained face recognition model.

2. The model training method as claimed in claim 1, wherein the steps of uploading, by each user terminal, device information thereof to the server, and allocating, by the server, a respective propagation step length and a respective aggregation weight to each user terminal based on the device information obtained from the plurality of user terminals, comprise:
uploading, by each user terminal, a computation capability value thereof and a number of training samples corresponding to the face image training set thereof to the server;
calculating, by the server, the propagation step length of each user terminal by using a pre-established propagation step length computation formula based on the computation capability values of the plurality of user terminals; wherein the propagation step length computation formula is determined according to a pre-established optimization problem regarding computation time;
calculating, by the server, a total number of the training samples of the plurality of user terminals, and determining a ratio of the number of the training samples of each user terminal to the total number of the training samples as the aggregation weight of each user terminal; and
sending, by the server, the respective propagation step length and the respective aggregation weight to each user terminal.

3. The model training method as claimed in claim 2, wherein the pre-established optimization problem regarding computation time, comprises:
$${min}_{{p}_{1} , … , {p}_{N}} max \{ \frac{{p}_{1} M N}{{c}_{1} C} , \frac{{p}_{2} M N}{{c}_{2} C} , … , \frac{{p}_{N} M N}{{c}_{N} C} \}$$
$$s . t .$$
$${\sum }_{i = 1}^{N} {p}_{i} = 1 , ∀ i = 1 , … , N$$
$$0 \leq {p}_{i} \leq 1 , ∀ i = 1 , … , N$$
where pᵢ represents a cutting ratio, which indicates a computation load rate allocated to an i-th user terminal uᵢ; N represents a total number of the plurality of user terminals; Cᵢ represents a computation capability value of the user terminal uᵢ;
$$C = {\sum }_{i = 1}^{N} {C}_{i}$$
represents a total computation capability value of the plurality of user terminals; cᵢ represents a ratio of the computation capability value of the user terminal uᵢ to the total computation capability value of the plurality of user terminals; M represents a total amount of computation required for the start node to complete the local joint processing; max {□} represents obtaining a maximum value; and
$${min}_{{p}_{1} , … , {p}_{N}}$$
represents minimization;
wherein a solution result of the pre-established optimization problem regarding computation time comprises:
$$\{ \begin{matrix}{p}_{i}^{*} = {c}_{i} , ∀ i = 1 , … , N \\ {m}^{*} = \frac{M N}{C}\end{matrix}$$
where p*ᵢ represents an optimal cutting ratio of the user terminal uᵢ; and m* represents a optimization result of a variable m introduced in a process of solving the pre-established optimization problem.

4. The model training method as claimed in claim 3, wherein the pre-established propagation step length computation formula is expressed as follows:
$${L}_{i} = {p}_{i}^{*} w = \frac{{C}_{i}}{{\sum }_{j = 1}^{N} {C}_{j}} w$$
where Lᵢ represents the propagation step length of the user terminal uᵢ; and w represents a total number of layers of an original network corresponding to each round global model.

5. The model training method as claimed in claim 1, wherein for each start node, the forward propagation in the local joint processing of each start node comprises:
forward propagating, by the start node, at least one layer corresponding to the propagation step length of the start node by using the batch of the face image training set thereof from a first layer of the current-time local model, and transmitting, by the start node, a feature map output by a local network corresponding to the forward propagation of the start node and an output layer serial number of the user terminal corresponding to the start node to a next user terminal along a forward direction of the ring topology starting from the start node;
for each forward current node traversed sequentially along the forward direction of the ring topology, taking a next layer corresponding to an output layer serial number of a previous user terminal along the forward direction of the ring topology as a start layer of the forward current node, forward propagating at least one layer corresponding to the propagation step length of the forward current node by using a computation result transmitted by the previous user terminal from the start layer of the forward current node, and transmitting a computation result obtained by a local network corresponding to the forward propagation of the forward current node to a next user terminal along the forward direction of the ring topology; wherein the forward current node is one of the plurality of user terminals traversed except the start node in the ring topology, and an end node is a last user terminal of the plurality of user terminals traversed in the ring topology;
except the end node, each forward current node transmits an output layer serial number thereof to a next user terminal; the computation result obtained by the local network is a feature map output by the local network corresponding to the forward propagation of the forward current node; and a computation result of the end node is a face recognition result;
comparing, by the start node, the face recognition result transmitted by the end node with a sample label in the batch of the face image training set to obtain a comparison result, and calculating a network loss value corresponding to the start node according to the comparison result.

6. The model training method as claimed in claim 5, wherein for each start node, the backward propagation in the local joint processing of each start node comprises:
transmitting, by the start node, the network loss value and the aggregation weight corresponding to the start node to the end node;
backward propagating, by the end node, at least one layer corresponding to the propagation step length of the end node from a last layer of the current-time local model by using the network loss value, calculating, by the end node, a local network gradient of a local network corresponding to the backward propagation of the end node, multiplying, by the end node, the local network gradient with the aggregation weight of the start node to obtain a weighted gradient corresponding to the end node and storing the weighted gradient corresponding to the end node; and transmitting the output layer gradient of a local network corresponding to the end node and an output layer serial number of the end node to a next user terminal along a backward direction of the ring topology;
for each backward current node traversed sequentially along the backward direction of the ring topology, taking a next layer corresponding to an output layer serial number of a previous user terminal along the backward direction of the ring topology as a start layer of the backward current node, backward propagating at least one layer corresponding to the propagation step length of the backward current node by using an output layer gradient transmitted by the previous user terminal from the start layer of the backward current node, calculating a local network gradient corresponding to the backward propagation of the backward current node, and multiplying the local network gradient with the aggregation weight of the start node to obtain a weighted gradient of the backward current node and storing the weighted gradient of the backward current node; and transmitting an output layer gradient and an output layer serial number of a local network corresponding to the backward current node to a next user terminal along the backward direction of the ring topology; wherein the backward current node is one of the plurality of user terminals traversed except the start node and the end node in the ring topology; and
taking, by the start node, a next layer corresponding to an output layer serial number of a previous user terminal in the backward direction of the ring topology as a start layer of the start node, backward propagating, by the start node, at least one layer corresponding to the propagation step length of the start node from the start layer of the start node by using an output layer gradient transmitted by the previous user terminal, calculating, by the start node, a local network gradient corresponding to the backward propagation thereof, and multiplying, by the start node, the local network gradient with the aggregation weight of the start node to obtain the weighted gradient corresponding to the start node and storing the weighted gradient.

7. The model training method as claimed in claim 6, wherein the step of updating the current-time local model of the start node based on weighted gradients generated by the start nodes in the local joint processing, comprises:
calculating a sum of weighted gradients corresponding to the start node based on the weighted gradients generated in the local joint processing performed by the start nodes; and
calculating a product of the sum of the weighted gradients corresponding to the start node and a preset learning rate, and subtracting the product from a parameter of the current-time local model of the start node to obtain an updated current-time local model of the start node, thereby when the local joint processing does not correspond to the preset number of times, using the updated current-time local model for next local joint processing.

8. The model training method as claimed in claim 1, wherein the step of uploading, by each user terminal, the locally-updated model parameter for the current-round training to the server for aggregation, comprises:
uploading, by each user terminal, the locally-updated model parameter for the current-round training to the server; and obtaining, by the server, an average value of the locally-updated model parameters of the plurality of user terminals as a parameter of the current-round updated global model.

9. The model training method as claimed in claim 1, wherein the server is a base station in a cellular network, and each user terminal is a user terminal device in the cellular network.

10. A face recognition method based on adaptive split learning-federated learning, applied to a target terminal, wherein the face recognition method comprises the following steps:
acquiring the trained face recognition model obtained through the model training method as claimed in claim 1, and an image to be recognized; wherein the target terminal is the server or one of the plurality of user terminals in the RingSFL system; and
inputting the image to be recognized into the trained face recognition model to obtain a face recognition result; wherein the face recognition result comprises attribute information of a face in the image to be recognized, and the attribute information comprises identity information.
